(19) United States
(12) Patent Application Publication
(10) Pub. No.: US 2012/0069162 A1
(43) Pub. Date: Mar. 22, 2012

(54) INFORMATION PROCESSING DEVICE, INFORMATION PROCESSING METHOD, REPRODUCTION DEVICE, REPRODUCTION METHOD, AND PROGRAM

(75) Inventors: Masashi OTA, Tokyo (JP); Noboru Murabayashi, Saitama (JP)

(73) Assignee: Sony Corporation, Tokyo (JP)

(21) Appl. No.: 13/231,022

(22) Filed: Sep. 13, 2011

(30) Foreign Application Priority Data
Sep. 22, 2010 (JP) 2010-211646

(51) Int. Cl. H04N 13/04

(52) U.S. Cl. 348/54; 348/E13.026

(57) ABSTRACT

An information processing device includes: a recording unit that records a 3D content including a left eye image and a right eye image; a parallax adjusting unit that adjusts parallax between the left eye image and the right eye image of the 3D content according to a recording rate or a transmission rate of the 3D content; and a transmission control unit that transmits the 3D content including the left eye image and the right eye image with the adjusted parallax to respective terminals as a transmission destination through a network.

### BACKGROUND

The present disclosure relates to an information processing device, an information processing method, a reproduction device, a reproduction method, and a program, and more particularly, to an information processing device, an information processing method, a reproduction device, a reproduction method, and a program, capable of reproducing 3D contents with proper parallax.

A content transmission service for home appliances such as a television receiver and a recording apparatus has been started. A user can watch various contents such as movies by streaming reproduction or the like, with the same feeling as watching television programs.

Recently, 3D contents which can be 3-dimensionally viewed have attracted attention. Video data of the 3D contents includes data for left eye images (L image) and right eye images (R image). There is a difference corresponding to parallax between a photography subject shown in the L image and a photography subject shown in the R image. The L image and the R image with an established parallax are alternately displayed and transmitted to the left eye and the right eye of the user using active shutter glasses, and thus it is possible to stereoscopically view the photography subject.

In the future, it is thought that the 3D contents will be transmitted even by content transmission services for home appliances described above.

Japanese Unexamined Patent Application Publication No. 2007-28526 and Japanese Unexamined Patent Application Publication No. 09-121370 are examples of the related art.

### SUMMARY

Generally, the amount of 3D content data is larger than the amount of 2D content data formed of 2-dimensional images. Accordingly, when many users simultaneously access a server transmitting contents and start watching the 3D contents, it is expected that traffic problems on the transmission paths increase as compared with a case of transmitting only 2D contents.

When many users simultaneously access the server and there is no margin due to congestion of the transmission paths, the transmission of data is discontinued, and the reproduction of the 3D contents is discontinued partway through reproduction or noises occur on the reproduced image.

When there is no margin on the transmission paths, it is conceivable perform a control to lower the transmission rate of the 3D contents on the server side. However, when only the transmission rate is adjusted with the parallax as is, the noises stand out, for example, when the transmission rate is low as compared with a case where the transmission rate is high. Accordingly, it is difficult to provide the user the 3-dimensional effect intended by the producers, and there is a possibility causing fatigue.

It is desirable to reproduce 3D contents with proper parallax.

According to an embodiment of the present disclosure, there is provided an information processing device including: a recording unit that records a 3D content including a left eye image and a right eye image; a parallax adjusting unit that adjusts parallax between the left eye image and the right eye image of the 3D content according to a recording rate or a transmission rate of the 3D content; and a transmission control unit that transmits the 3D content including the left eye image and the right eye image with the adjusted parallax to respective terminals as a transmission destination through a network.

In the information processing device, when the recording rate or the transmission rate of the 3D content is higher than a threshold value, the parallax adjusting unit may adjust the parallax between the left eye image and the right eye image such that the parallax is larger than that of a case where the recording rate or the transmission rate of the 3D content is lower than the threshold value.

The information processing device may further include a detection unit that detects the number of terminals. In this case, the transmission control unit may determine the transmission rate of the 3D content according to the number of terminals detected by the detection unit, and the parallax adjusting unit may adjust the parallax between the left eye image and the right eye image of the 3D content according to the transmission rate determined by the transmission control unit.

In the information processing device, the recording unit may record a plurality of 3D contents with different viewpoints, and records data with different recording rates as data of the 3D contents, and the information processing device may further include: an extraction unit that extracts characteristics of the 3D contents, and calculates evaluation values of the 3D contents recorded on the recording unit on the basis of the extracted characteristics; and a selection unit that selects a 3D content of a transmission target from the plurality of 3D contents with different viewpoints on the basis of the evaluation values. In this case, the parallax adjusting unit adjusts the parallax between the left eye image and the right eye image of the 3D content selected by the selection unit.

In the information processing device, the selection unit may select the 3D content with the highest evaluation value.

In the information processing device, the selection unit may select data of the recording rate based on the evaluation value, as data of the 3D content.

According to another embodiment of the present disclosure, there is provided an information processing method including: recording a 3D content including a left eye image and a right eye image; adjusting parallax between the left eye image and the right eye image of the 3D content according to a recording rate or a transmission rate of the 3D content; and transmitting the 3D content including the left eye image and the right eye image with the adjusted parallax to terminals as a transmission destination through a network.

According to still another embodiment of the present disclosure, there is provided a program for causing a computer to execute the processes of: recording a 3D content including a left eye image and a right eye image; adjusting parallax between the left eye image and the right eye image of the 3D content according to a recording rate or a transmission rate of the 3D content; and transmitting the 3D content including the left eye image and the right eye image with the adjusted parallax to terminals as a transmission destination through a network.

According to still another embodiment of the present disclosure, there is provided a reproduction device including: a reception unit that receives a 3D content including a left eye image and a right eye image transmitted from an information processing device connected through a network; a parallax adjusting unit that adjusts parallax between the left eye image and the right eye image of the 3D content according to a recording rate of the 3D content; and a reproduction unit that reproduces the 3D content including the left eye image and the right eye image with the adjusted parallax.

In the reproduction device, when the recording rate of the 3D content is higher than a threshold value, the parallax adjusting unit may adjusts the parallax between the left eye image and the right eye image such that the parallax is larger than that of a case where the recording rate of the 3D content is lower than the threshold value.

In the reproduction device, a plurality of 3D contents with different viewpoints may be recorded in the information processing device, and data with different recording rates may be recorded as data of the 3D contents.

The reproduction device may further include a detection unit that detects communication quality with respect to the information processing unit. In this case, the reception unit may receive the 3D content with a recording rate based on the communication quality detected by the detection unit.

In the reproduction device, the reception unit may receive a plurality of 3D contents with different viewpoints, and the reproduction device may further include: an extraction unit that extracts characteristics of the 3D contents received by the reception unit, and calculates evaluation values of the plurality of 3D contents with different viewpoints on the basis of the extracted characteristics; and a selection unit that selects a 3D content with the highest evaluation value from the plurality of 3D contents with different viewpoints. In this case, the parallax adjusting unit may adjust the parallax between the left eye image and the right eye image of the 3D content selected by the selection unit.

In the reproduction device, the reception unit may receive data with a recording rate based on the evaluation value calculated on the basis of the characteristics of the 3D content of a reproduction target, as data of the 3D content of the reproduction target, and the parallax adjusting unit may adjust the parallax between the left eye image and the right eye image of the 3D content, the data of which is selected by the reception unit.

In the reproduction device, the reception unit may receive information of the evaluation value transmitted from the information processing device, and may receive data with a recording rate based on the received evaluation value.

According to still another embodiment of the present disclosure, there is provided a reproduction method including: receiving a 3D content including a left eye image and a right eye image transmitted from an information processing device connected through a network; adjusting parallax between the left eye image and the right eye image of the 3D content according to a recording rate of the 3D content; and reproducing the 3D content including the left eye image and the right eye image with the adjusted parallax.

According to still another embodiment of the present disclosure, there is provided a program for causing a computer to execute the processes of: receiving a 3D content including a left eye image and a right eye image transmitted from an information processing device connected through a network; adjusting parallax between the left eye image and the right eye image of the 3D content according to a recording rate of the 3D content; and reproducing the 3D content including the left eye image and the right eye image with the adjusted parallax.

In the first embodiment of the present disclosure, the 3D content including the left eye image and the right eye image is recorded, the parallax between the left eye image and the right eye image of the 3D contents is adjusted according to the recording rate or the transmission rate of the 3D content, and the 3D content including the left eye image and the right eye image with the adjusted parallax is transmitted to the terminals as the transmission destination through the network.

In the other embodiment of the present disclosure, the 3D content including the left eye image and the right eye image transmitted from the information processing device connected through the network, the parallax between the left eye image and the right eye image of the 3D content is adjusted according to the recording rate of the 3D content, and the 3D content including the left eye image and the right eye image with the adjusted parallax is reproduced.

According to the embodiments of the present disclosure, it is possible to reproduce 3D contents with proper parallax.

### BRIEF DESCRIPTION OF THE DRAWINGS

FIG. 1 is a diagram illustrating an example of a configuration of a content transmission system.

FIG. 2 is a diagram illustrating an example of 3D contents recorded on a recording medium of a content server.

FIG. 3 is a block diagram illustrating an example of a hardware configuration of the content server.

FIG. 4 is a block diagram illustrating an example of a functional configuration of the content server.

FIG. 5 is a block diagram illustrating an example of a configuration of a client terminal.

FIG. 6 is a flowchart illustrating a reproduction process of the client terminal.

FIG. 7 is a flowchart illustrating a transmission process of the content server.

FIG. 8 is a diagram illustrating an example of a relationship between the number of accesses and a transmission rate.

FIG. 9 is a flowchart illustrating a key frame estimation value calculating process of the content server.

FIG. 10 is a diagram illustrating an example of the amount of image characteristics.

FIG. 11 is a flowchart illustrating another transmission process of the content server.

FIG. 12 is a flowchart illustrating still another transmission process of the content server.

FIG. 13 is a block diagram illustrating an example of another functional configuration of the content server.

FIG. 14 is a block diagram illustrating an example of another configuration of the client terminal.

FIG. 15 is a flowchart illustrating a transmission process of the content server.

FIG. 16 is a flowchart illustrating a reproduction process of the client terminal.

FIG. 17 is a diagram illustrating an example of a relationship between communication quality and a recording rate.

FIG. 18 is a flowchart illustrating another reproduction process of the client terminal.

FIG. 19 is a flowchart illustrating still another reproduction process of the client terminal.

### DETAILED DESCRIPTION OF EMBODIMENTS

Hereinafter, embodiments of the present disclosure will be described. The description is performed in the following order.

1. First Embodiment (an example in which various controls are performed on the server side)

2. Second Embodiment (an example in which various controls are performed on the client terminal side)

### First Embodiment

Configuration of Content Transmission System

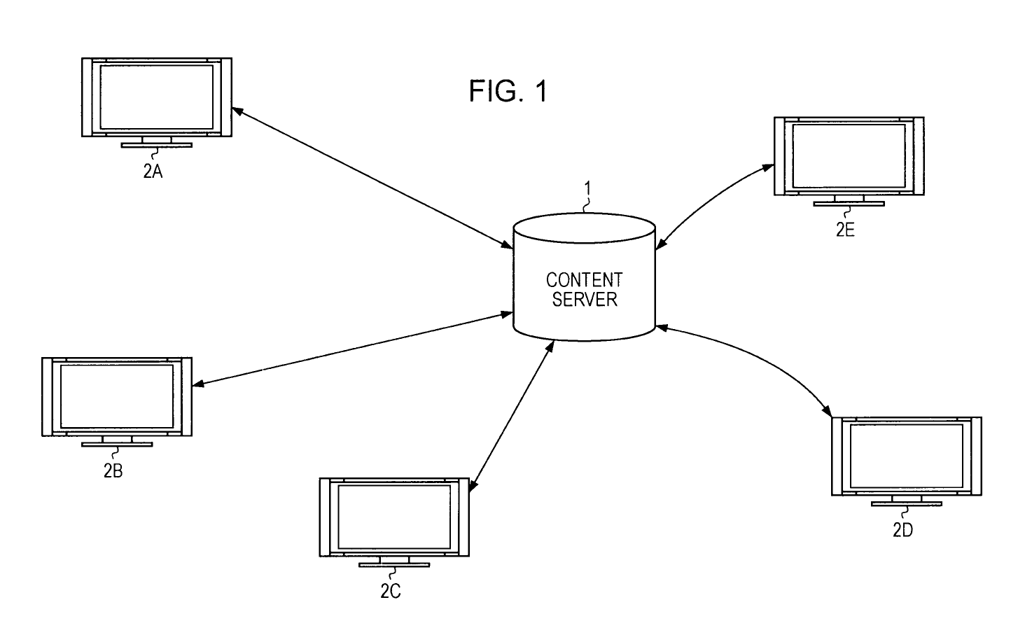

FIG. 1 is a diagram illustrating an example of a configuration of a content transmission system according to an embodiment of the present disclosure.

In the content transmission system shown in FIG. 1, a content server 1 and client terminals 2A to 2E are connected through a network such as the Internet. In the example shown in FIG. 1, the client terminals 2A to 2E are television receivers.

Hereinafter, when it is not necessary to discriminate the client terminals 2A to 2E, the client terminals are appropriately referred to as a client terminal 2. In FIG. 1, only five client terminals of the client terminals 2A to 2E are shown, but more client terminals may be connected to the content server 1.

The content server 1 records a plurality of 3D contents as transmittable contents on a recording medium. Each 3D content includes video data and audio data that are data of L images and R images. The content server 1 reads the 3D content from the recording medium according to the request of the client terminal 2, and transmits the 3D content through the network.

The client terminal 2 accesses the content server 1 through the network, and displays a selection screen of the 3D content. When a predetermined 3D content is selected by a user by an operation of a remote controller or the like, the client terminal 2 requests the content server 1 to transmit the 3D content selected by the user. The client terminal 2 receives and reproduces the 3D content transmitted from the content server 1, alternately displays the L images and the R images on a display, and outputs sound from a speaker. The user with active shutter glasses can stereoscopically view the images of the 3D content.

As described above, the client terminal 2 at least has a browser function of accessing the content server 1 and displaying the selected image on the screen, and a function of reproducing the 3D content and displaying the 3D images (L images and R images).

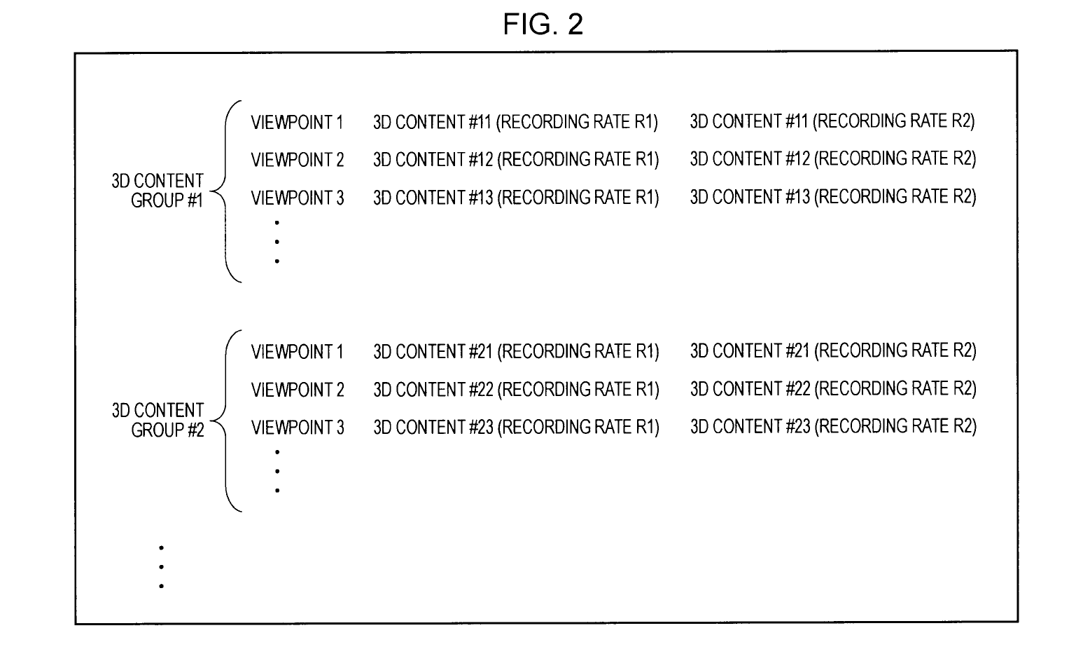

Hereinafter, the 3D content recorded on the recording medium of the content server 1 will be described. FIG. 2 is a diagram illustrating an example of the 3D content recorded on the recording medium of the content server 1.

As shown in FIG. 2, in the content server 1, a plurality of related 3D contents are managed as a group. For example, the 3D content group #1 is a content of a soccer match, and the 3D content group #2 is a content of a movie.

The content group #1 is a 3D content group obtained by capturing images of any soccer match using 3D cameras (two imaging units provided at a distance corresponding to the parallax) at the same time from different locations.

For example, a 3D content #11 included in the 3D content group #1 is a 3D content obtained by capturing an image of the soccer match from a viewpoint 1, and a 3D content #12 is a 3D content obtained by capturing an image of the same soccer match from a viewpoint 2. A 3D content #13 is a 3D content obtained by capturing an image of the same soccer match from a viewpoint 3. The reproduction times of the 3D contents #11 to #13 included in the group #1 are the same time.

A plurality of data with different recording rates is recorded as data of the 3D contents of the viewpoints in the recording medium of the content server 1. For example, data with a recording rate R1 and data with a recording rate R2 are recorded in the 3D content #11. Similarly, data with the recording rate R1 and data with the recording rate R2 are recorded in the 3D content of the other viewpoint. For example, the recording rate R2 is higher than the recording rate 1.

Similarly in the 3D content group #2 or the other 3D content group, each 3D content group includes a plurality of 3D contents obtained by capturing images of the same target at the same time from different locations. A plurality of data with different recording rates are recorded as data of the 3D contents of the viewpoints.

As described above, the content server 1 is provided with the plurality of related 3D contents for each one content (3D content group). The content server 1 is provided with data with different recording rates, as respective data of the related 3D contents. Accordingly, the user of the client terminal 2 can select a desired viewpoint and can watch various contents, such as soccer matches and movies. As for movies of sports programs, it may be possible to enjoy active movies as compared with movies visible in only one determined direction.

The 3D contents included in the same group may be 3D contents related in meaning different from the viewpoint, for example, 3D contents of the same actor and 3D contents of the same genre.

Configuration of Devices

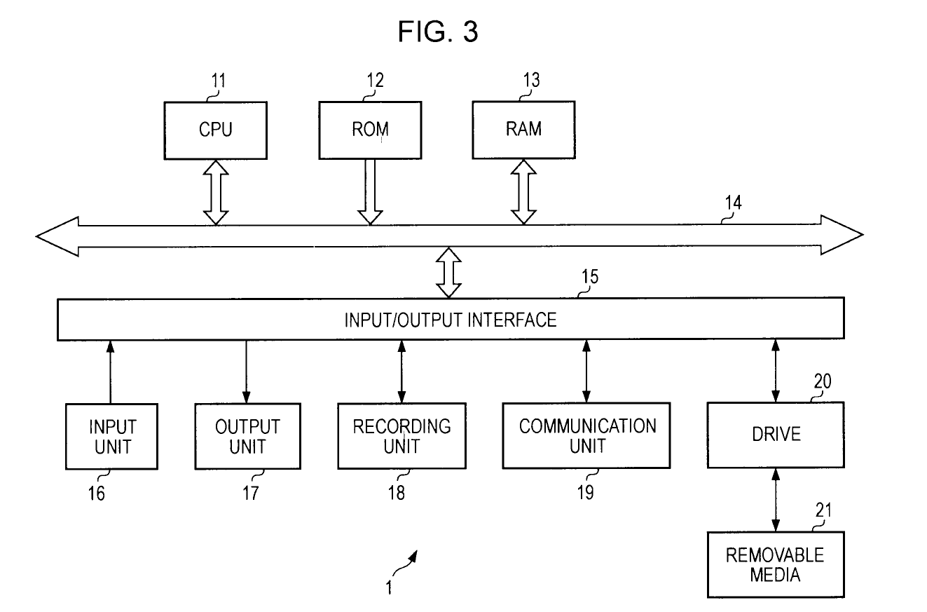

FIG. 3 is a block diagram illustrating an example of a hardware configuration of the content server 1.

A CPU (Central Processing Unit) 11, a ROM (Read Only Memory) 12, and a RAM (Random Access Memory) 13 are connected to each other through a bus 14.

In addition, the bus 14 is additionally connected to an input/output interface 15. The input/output interface 15 is connected to an input unit 16 including a keyboard and a mouse and an output unit 17 including a display and a speaker. The input/output interface 15 is connected to a recording unit 18, a communication unit 19, and a driver 20 driving a removable media 21.

The recording unit 18 is formed of a recording medium such as a HDD (Hard Disk Drive) and an SSD (Solid State Drive), and records 3D contents as shown in FIG. 2. The 3D contents recorded in the recording unit 18 are appropriately read by the control of the CPU 11, and are supplied to the communication unit 19 through the input/output interface 15.

The communication unit 19 is formed of a network interface or the like, and communicates with the client terminal 2 through the network. The communication unit 19 receives a request from the client terminal 2, and transmits the 3D content read from the recording unit 18 and supplied through the input/output interface 15, to the client terminal 2.

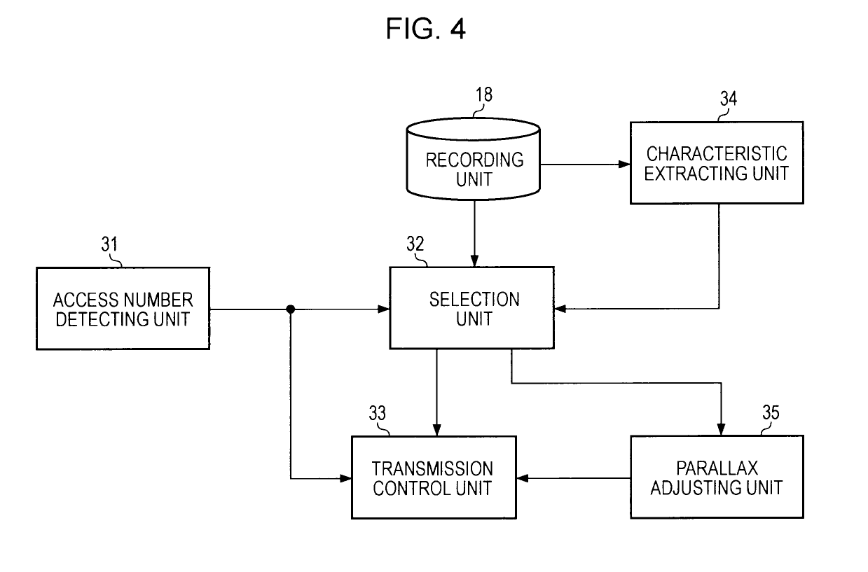

FIG. 4 is a block diagram illustrating an example of a functional configuration of the content server 1.

At least a part of functional units shown in FIG. 4 is realized by a predetermined program executed by the CPU 11 shown in FIG. 3. In the content server 1, an access number detecting unit 31, a selection unit 32, a transmission control unit 33, a characteristic extracting unit 34, and a parallax adjusting unit 35 are realized.

The access number detecting unit 31 detects the number of accessed client terminals 2, and outputs information of the detected number of accesses to the selection unit 32 and the transmission control unit 33. As will be described later, the number of accessed client terminal 2 is used to determine the transmission rate when transmitting the 3D content to the client terminals 2 and to determine the recording rate of the 3D content transmitted to the client terminals 2.

The selection unit 32 selects a 3D content of a transmission target, from the 3D contents recorded in the recording unit 18. The 3D content of the transmission target is selected, for example, according to the number of accessed client terminals 2 detected by the access number detecting unit 31 or a key frame evaluation value of the 3D content calculated by the characteristic calculating unit 34. The selection unit 32 reads the selected 3D content from the recording unit 18, and outputs the 3D content to the transmission control unit 33. To adjust parallax, the selection unit 32 outputs the 3D content read from the recording unit 18 to the parallax adjusting unit 35.

The transmission control unit 33 controls the communication unit 19 shown in FIG. 3 to control the transmission of the 3D content. The 3D content supplied from the selection unit 32, or the 3D content with the adjusted parallax supplied from the parallax adjusting unit 35 is transmitted from the transmission control unit 33. The transmission control unit 33 appropriately controls the transmission rate when transmitting the 3D content, according to the number of accesses detected by the access number detecting unit 31.

The characteristic extracting unit 34 extracts characteristics of the 3D contents recorded in the recording unit 18, and calculates the key frame evaluation value for each section of the 3D contents on the basis of the extracted characteristics. The calculation of the key frame evaluation value performed by the characteristic extracting unit 34 will be described in detail later. The characteristic extracting unit 34 outputs information of the key frame evaluation value for each section of the 3D contents to the selection unit 32.

For example, the parallax adjusting unit 35 sets a value corresponding to the recording rate of the 3D content, as a value of a parallax parameter of the 3D content supplied from the selection unit 32, to adjust the parallax. The parallax adjusting unit 35 outputs the 3D content with the adjusted parallax to the transmission control unit 33. The parallax parameter is a parameter regulating the parallax between the L image and the R image of the 3D content, and is included in the video data of the 3D content. At the time of displaying the 3D image, the client terminal 2 receiving the 3D content sets the parallax between the L image and the R image on the basis of the parallax parameter and displays the L image and the R image. There is a different in depth of the photography subject which the user feels, according to variation of the parallax.

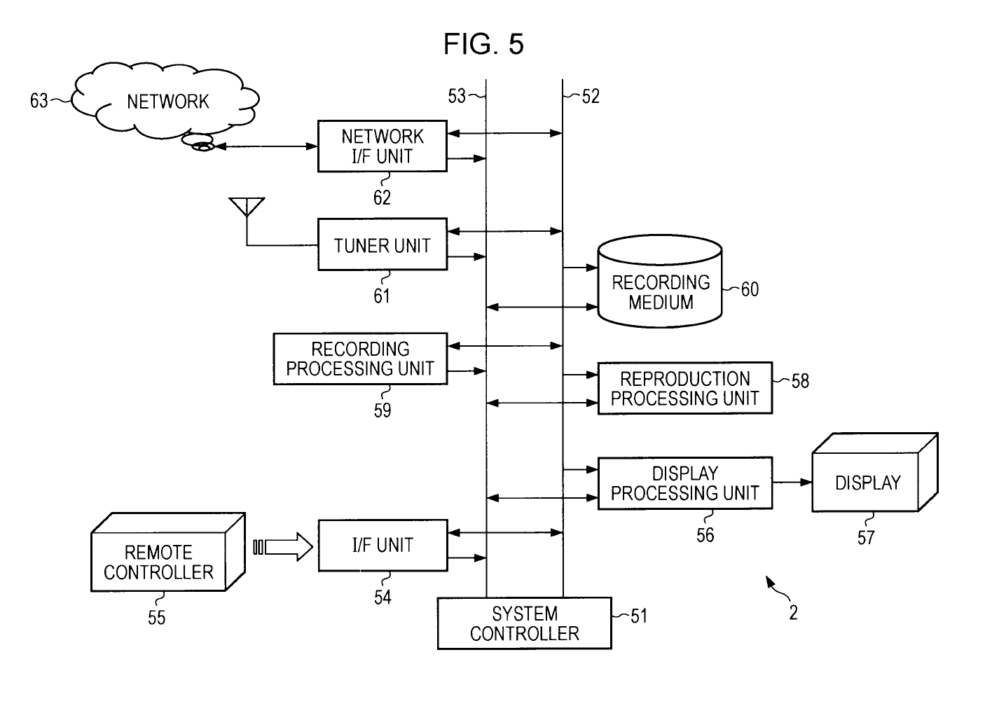

FIG. 5 is a block diagram illustrating an example of a configuration of the client terminal 2.

A system controller 51 controls units of the client terminal 2 through a control bus 52. Transmission and reception of data performed among the units according to the control performed by the system controller 51 are performed through a data bus 53. For example, the system controller 51 controls a network I/F unit 62 to access the content server 1, and requests transmission of the 3D content selected by the user.

The I/F unit 54 receives a signal from a remote controller 55, and outputs information representing an operation of the user to the system controller 51.

A display processing unit 56 displays the image of the 3D content transmitted from the content server 1 or the selection screen of the 3D content on a display 57 formed of an LCD (Liquid Crystal Display) or the like. For example, when the reproduction of the 3D content is performed by a reproduction processing unit 58 and the video data including the L image and the R image is supplied, the display processing unit 56 alternately displays the L image and the R image on the display 57.

When the 3D content transmitted from the content server 1 and received by the network I/F unit 62 is supplied, the reproduction processing unit 58 performs a reproduction process of the 3D content. The reproduction process includes processes such as decompressing of a compressed 3D content, decoding of the non-compressed video data and audio data obtained by the decompression, and setting the parallax based on the parallax parameter.

The reproduction processing unit 58 outputs the video data including the L image and the R image obtained by the reproduction process, to the display processing unit 56. The reproduction processing unit 58 outputs sound of the 3D content from a speaker (not shown) on the basis of the audio data obtained by the reproduction process. The reproduction processing unit 58 also performs reproduction of a content transmitted through broadcasting waves and received by a tuner unit 61, and a content recorded on the recording medium 60.

The recording processing unit 59 compresses the content received by the tuner unit 61 in a predetermined manner, and records the compressed content in the recording medium 60 such as HDD and SSD. In this example, the client terminal 2 has a recording function.

The tuner unit 61 performs a demodulation process, an A/D conversion process, and the like on a signal supplied from an antenna, and acquires the data of the content transmitted through the broadcasting waves. When the recording of the content is instructed by the user, the data of the content acquired by the tuner unit 61 is supplied to the recording processing unit 59 and is recorded on the recording medium 60.

The network I/F unit 62 communicates with the content server 1 through the network 63. The network I/F unit 62 requests the content server 1 to transmit the 3D content selected by the user, receives the 3D content transmitted from the content server 1 according to the request, and outputs the 3D content to the reproduction processing unit 58 and the like.

Operations of Devices

Hereinafter, operations of the content server 1 and the client terminal 2 having the configurations described above will be described.

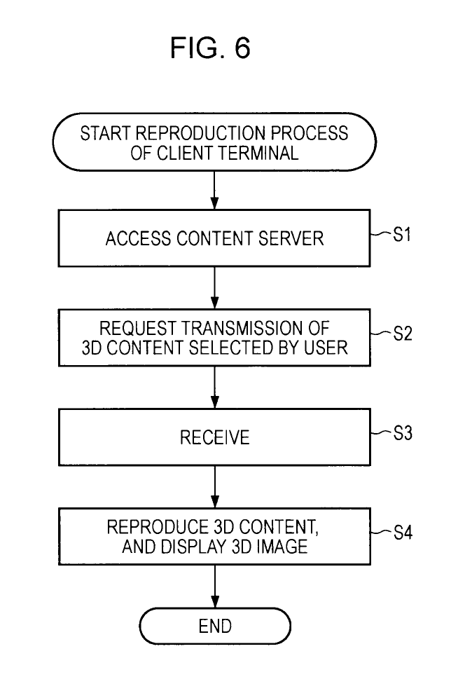

First, a process of the client terminal 2 reproducing the 3D content will be described with reference to the flowchart shown in FIG. 6.

In Step S1, the system controller 51 controls the network I/F unit 62 to access the content server 1. When the network I/F unit 62 accesses the content server 1, the network I/F unit 62 outputs the information transmitted from the content server 1 to the display processing unit 56 to display the selection screen of the 3D contents. A list of the 3D contents recorded in the recording unit 18 of the content server 1 is displayed on the selection screen, and the user operates the remote controller 55 or the like to select a desired 3D content.

In Step S2, the system controller 51 requests the content server 1 to transmit the 3D content selected by the user. In this case, only the group of the 3D contents may be selected by the user, and even the viewpoint or the recording rate may be selected. In the content server 1, the transmission of the 3D content to the client terminal 2 is started according to the request from the client terminal 2.

In Step S3, the network I/F unit 62 receives the 3D content transmitted from the content server 1.

In Step S4, the reproduction processing unit 58 reproduces the 3D content received by the network I/F unit 62, and displays the 3D image on the display 57. While the 3D content selected by the user is transmitted, the processes of Step S3 and the later are repeated. When the reproduction of the 3D content is ended, the process is ended.

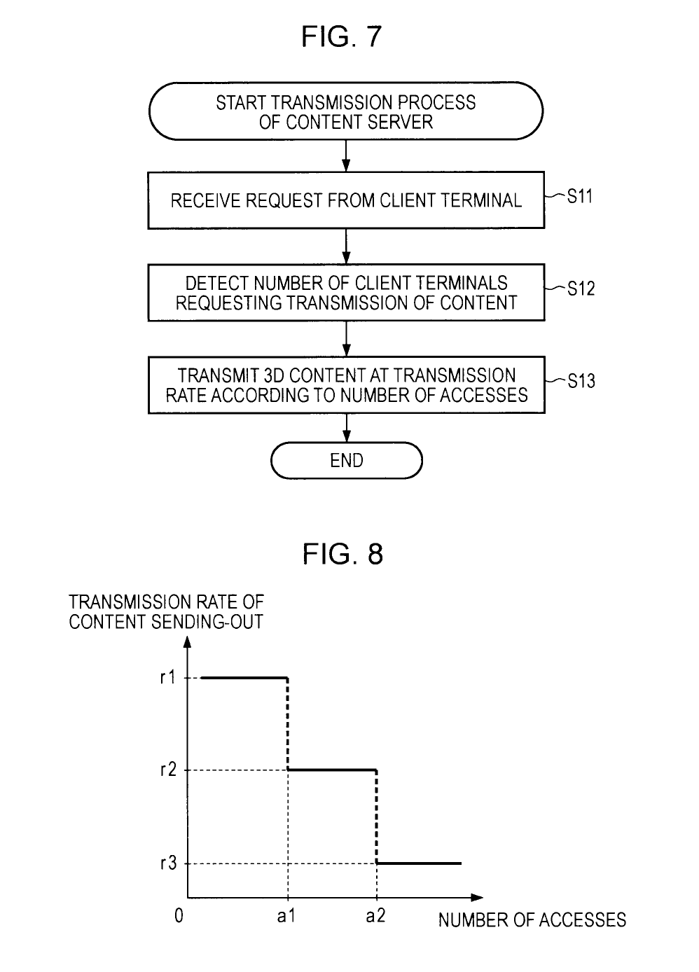

Next, a process of the content server 1 transmitting the 3D content will be described with reference to the flowchart shown in FIG. 7.

The process shown in FIG. 7 is a process of controlling the transmission rate according to the number of accessed client terminals 2 and transmitting the 3D contents.

In Step S11, the access number detecting unit 31 receives the request from the accessed client terminal 2. The request from the client terminal 2 includes information designating the 3D content that is the transmission target.

In Step S12, the access number detecting unit 31 detects the number of client terminals 2 requesting the transmission of the 3D contents, considers the detected number as the number of accesses, and outputs information about the number to the transmission control unit 33.

In Step S13, the transmission control unit 33 determines the transmission rate of the 3D content according to the number of accesses detected by the access number detecting unit 31. The transmission control unit 33 transmits the 3D content to each of the client terminals 2 at the determined transmission rate. The 3D content requested to be transmitted from the client terminals 2 is read from the recording unit 18 by the selection unit 32, and is supplied to the transmission control unit 33.

For example, when the number of accesses is larger than a threshold value, the transmission control unit 33 selects the first transmission rate, and transmits the 3D content of the transmission target to the client terminals 2 at the first transmission rate. When the number of accesses is smaller than the threshold value, the transmission control unit 33 selects the second transmission rate higher than the first transmission rate, and transmits the 3D content of the transmission target to the client terminals 2 at the second transmission rate.

When the recording rate of the 3D content requested to be transmitted by the client terminals 2 is higher than the transmission rate selected according to the number of accesses, the transmission control unit 33 re-encodes the 3D content of the transmission target to transmit the 3D content at the selected transmission rate. The transmission control unit 33 transmits the 3D content, the recording rate of which is lowered by the re-encoding. When only the group and the viewpoint of the 3D content of the transmission target are selected by the user and the recording rate is not selected, the data may be transmitted at a recording rate equal to or lower than the selected transmission rate. In this case, it is not necessary to re-encode the 3D content.

FIG. 8 is a diagram illustrating an example of a relationship between the number of accesses and the transmission rate.

The horizontal axis shown in FIG. 8 represents the number of accessed terminals 2, and the vertical axis represents the transmission rate. In the example shown in FIG. 8, when the number of accesses is equal to or more than 1 and less than a1, the transmission rate of the 3D content is considered as r1, and when the number of accesses is equal to or more than a1 and less than a2, the transmission rate of the 3D content is r2 lower than r1. When the number of accesses is equal to or more than a2, the transmission rate of the 3D content is r3 lower than r2. The transmission control unit 33 has information representing the relation between the number of accesses and the transmission rate, and selects the transmission rate according to the information.

As described above, by controlling the transmission rate according to the number of accesses, the server 1 can transmit the 3D content to the client terminals 2 without discontinuing the data. Meanwhile, the user of the client terminal 2 can watch the 3D content without interruption of display or noises.

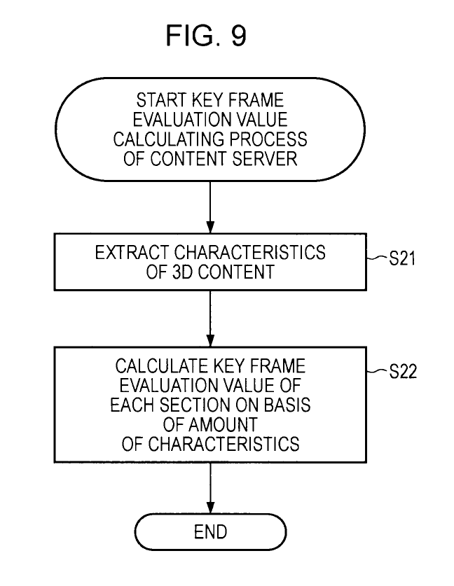

Next, a process of the content server 1 calculating the key frame evaluation value will be described with reference to the flowchart shown in FIG. 9.

The key frame evaluation value is a value representing excitement of the 3D content. As will be described later, the key frame evaluation value is used to select the viewpoint of the 3D content of the transmission target and to select the recording rate. The process shown in FIG. 9 is performed before the selection of the viewpoint of the 3D content of the transmission target or the selection of the recording rate.

In Step S21, the characteristic extracting unit 34 pays attention to the 3D contents recorded in the recording unit 18, and extracts characteristics of the 3D contents to which the attention is paid. As for the 3D contents, the recording rates of which are different and the substances of which are the same, the 3D content of any one recording rate is used to extract the characteristics.

For example, characteristics are extracted with respect to the video data and the audio data of the 3D content as a target, the amount of image characteristics is extracted from the video data, and the amount of sound characteristics is extracted from the audio data. The amount of image characteristics includes the amount of camera characteristics Fc (the amount of characteristics based on affine coefficients such as pan Fcp, tilt Fct, and zoom Fcz), and the amount of 3D characteristics Fd (the amount of characteristics based on the amount of parallax between the L image and the R image or the amount of depth). Meanwhile, the amount of sound characteristics includes sound power spectrum Fa.

In Step S22, the characteristic extracting unit 34 calculates the key frame evaluation value for each predetermined section of the 3D content on the basis of the amount of image characteristics and the amount of sound characteristics. When the key frame evaluation values for each section of all the 3D contents are calculated, the process is ended.

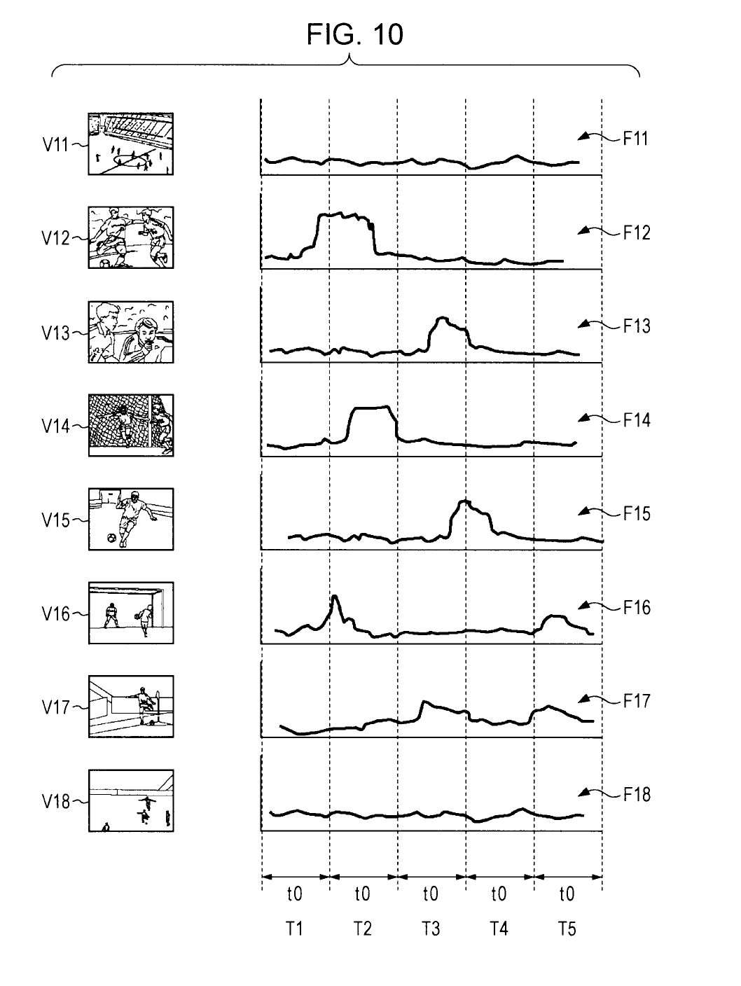

FIG. 10 is diagram illustrating an example of the amount of image characteristics.

Video data V11 to V18 are video data of the 3D contents #11 to #18 included in the 3D content group #1, respectively. In this example, the 3D contents obtained by capturing images of the same soccer match from 8 viewpoints are included in the 3D content group #1.

In the example shown in FIG. 10, although only 1-frame image is shown as the video data of the 3D content of each viewpoint, actually, the video data of the 3D content of each viewpoint includes data of a plurality of images in which the L images and the R images are alternately arranged in the display order.

Time series F11 to F18 shown on the right side of the video data V11 to V18 are time series of the amount of image characteristics of the video data V11 to V18, respectively. It is possible to obtain the time series of the amount of sound characteristics from the audio data of the 3D contents #11 to #18 corresponding to the video data V11 to V18 in the same manner.

The calculation of the key frame evaluation value is performed for each predetermined section t0 using the amount of image characteristics and the amount of sound characteristics in the section t0 as shown in FIG. 10.

Herein, weight coefficients of the amounts of characteristics of pan Fcp, tilt Fct, and zoom Fcz that are the amounts of camera characteristics are kp, kt, and kz, a weight coefficient of the amount of 3D characteristics is kd, and a weight coefficient of the amount of sound characteristics of the sound spectrum power Fa that is the amount of sound characteristics is ka.

In this case, the key frame evaluation value F is acquired, for example, by the following formula (1).

F=kp·Fcp+kt·Fct+kz·Fcz+kd·Fd+ka·Fa (1)

In this case, relation of the weight coefficients is represented by the following formula (2).

kp+kt+kz+kd+ka=1 (2)

The information of the key frame evaluation values for each 3D contents calculated as described above is recorded in the recording unit 18. The information of the key frame evaluation values recorded in the recording unit 18 is appropriately supplied from the characteristic extracting unit 34 to the selection unit 32.

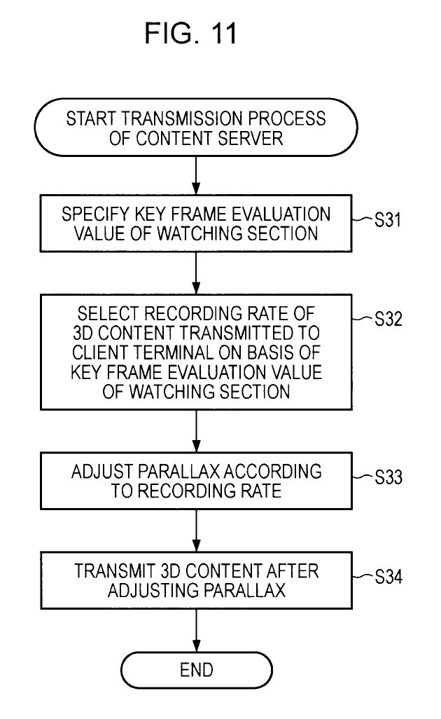

Next, another process of the content server 1 transmitting the 3D content will be described with reference to the flowchart shown in FIG. 11.

The process shown in FIG. 11 is a process of changing the recording rate of the 3D content transmitted to the client terminal 2 according to the key frame evaluation value, and adjusting the parallax of the 3D content according to the recording rate. For example, the process shown in FIG. 11 starts when the 3D content is reproduced on the client terminal 2 by performing the process shown in FIG. 6.

In Step S31, the selection unit 32 specifies the key frame evaluation value of the section of the 3D content being transmitted to each client terminal 2, that is, the section of the 3D content being watched on each client terminal 2. The specifying of the key frame evaluation value is performed by referring to the information of the key frame evaluation value supplied from the characteristic extracting unit 34 to the selection unit 32.

In Step S32, the selection unit 32 selects the recording rate of the 3D content transmitted to the client terminal 2 according to the key frame evaluation value of the section being watched.

Since the section in which the key frame evaluation value is high is a section with high excitement, it is thought that the user wants to watch the section with high excitement in high definition. When a predetermined 3D content is being transmitted to the client terminal 2, the selection unit 32 selects data of the recording rate R2 that is the higher recording rate as the transmission target, for example, in the section in which the key frame evaluation value is higher than the threshold value. The selection unit 32 selects data of the recording rate R1 that is the lower recording rate as the transmission target in the section in which the key frame evaluation value is lower than the threshold value. The selection unit 32 outputs the data of the 3D content of the transmission target to the parallax adjusting unit 35.

In Step S33, the parallax adjusting unit 35 adjusts the parallax of the 3D content supplied from the selection unit 32 according to the recording rate. For example, when the recording rate of the 3D content of the transmission target is the recording rate R2, the parallax adjusting unit 35 sets a default value as the value of the parallax parameter. When the recording rate of the 3D content is the recording rate R1, the parallax adjusting unit 35 sets a value smaller than the default value as the parallax parameter.

That is, the parallax adjusting unit 35 sets parallax larger than the parallax of the 3D content with the low recording rate with respect to the 3D content with the high recording rate. The parallax adjusting unit 35 sets parallax smaller than the parallax of the 3D content with the high recording rate with respect to the 3D content with the low recording rate. The parallax adjusting unit 35 outputs the 3D content with the adjusted parallax to the transmission control unit 33.

When the recording rate of the 3D content is low, generally, the amount of noises (compression noise such as MPEG and MVC) shown on the 3D image increases more than that of the case where the recording rate of the 3D content is high. Even when the amount of noises shown on the 3D image is large, the 3-dimensional effect which the user feels is unnatural and fatigue may increase when the same amount of parallax as the case where the amount of noises is small is provided. Accordingly, when the recording rate of the 3D content is low, it is possible to prevent the unnatural 3-dimensional effect or fatigue from being provided to the user, by reducing the parallax.

In Step S34, the transmission control unit 33 transmits the 3D content with the adjusted parallax to the client terminal 2. The reproduction of the 3D content is performed on the client terminal 2 receiving the 3D content transmitted by the transmission control unit 33.

By the process described above, the content server 1 can adjust the quality of the 3D image for each section according to the degree of excitement. The content server 1 adjusts the parallax according to the recording rate to prevent the unnatural 3-dimensional effect or fatigue from being provided to the user, and thus it is possible to display a more easily visible 3D image.

The 3D content of a predetermined recording rate selected by the selection unit 32 may be transmitted as is, without performing the adjustment of the parallax.

The adjustment of the parallax may be performed after the process shown in FIG. 7. In this case, when the 3D content is transmitted at the high transmission rate, the parallax larger than that of the case of transmitting the 3D content at the low transmission rate is set and the 3D content is transmitted. When the 3D content is transmitted at the low transmission rate, the parallax smaller than that of the case of transmitting the 3D content at the high transmission rate is set and the 3D content is transmitted.

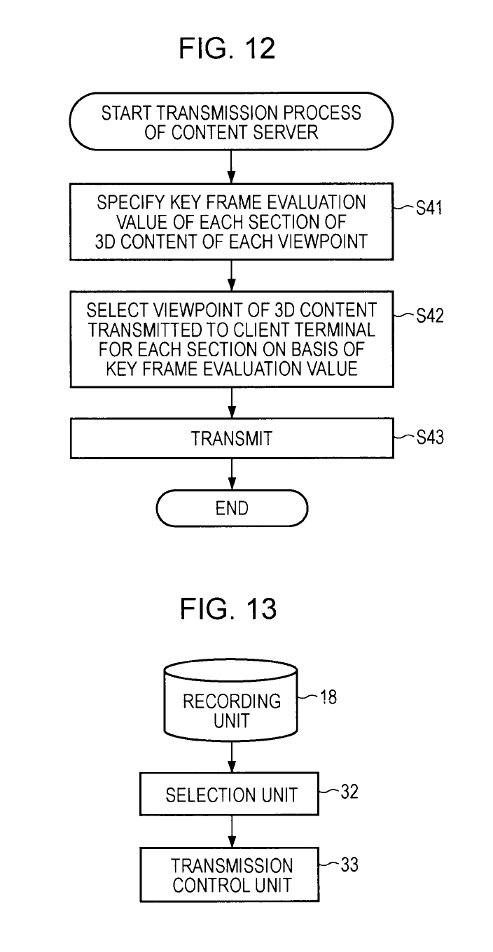

Next, still another process of the content server 1 transmitting the 3D content will be described with reference to the flowchart shown in FIG. 12.

The process shown in FIG. 12 is a process of selecting the viewpoint of the 3D content transmitted to the client terminal 2 according to the key frame evaluation value. In this case, from the client terminal 2, the selection of the 3D content group of the transmission target is performed, but the selection of the viewpoint is not performed. The process shown in FIG. 12 is started, for example, when the transmission of a predetermined 3D content group is requested by the client terminal 2.

In Step S41, the selection unit 32 specifies the key frame evaluation value for each section of the 3D content of each viewpoint, included in the 3D content group requested to be transmitted.

In Step S42, the selection unit 32 pays attention to the sequence from the leading section, and selects the 3D content of the viewpoint with the highest key frame evaluation value in the attended section, as the transmission target. The selection unit 32 outputs the selected 3D content to the transmission control unit 33.

Determining the key frame evaluation value for each section on the basis of only the amount of image characteristics of each section irrespective of the amount of sound characteristics will be described with reference to the example shown in FIG. 10. For example, in the section T1 that is the leading section and the section T2 subsequent to the section T1, the selection unit 32 selects the 3D content (the 3D content including the video data V12) of the viewpoint 2 with the highest key frame evaluation value in the sections, as the transmission target. In the section T3 subsequent to the section T2, the selection unit 32 selects the 3D content (the 3D content including the video data V13) of the viewpoint 3 with the highest key frame evaluation value in the section, as the transmission target.

That is, the selection unit 32 selects the 3D content of the viewpoint with the most excitement at that time, as the transmission target. In the client terminal 2, the 3D image is displayed automatically changing to the viewpoint considered to be the most exciting.

In Step S43, the transmission control unit 33 transmits the 3D content selected by the selection unit 32 to the client terminal 2. The 3D content is reproduced on the client terminal 2 receiving the 3D content transmitted by the transmission control unit 33.

The process shown in FIG. 11 is performed after the process of Step S43, and the selection of the recording rate and the adjustment of the parallax of the 3D content may be performed in combination with the process of selecting the viewpoint according to the key frame evaluation value.

Since the 3D contents included in one 3D content group are images captured at different locations, there is a difference in the key frame evaluation value, that is, excitement, according to the difference in substances of the video data and the audio data, even in the same section. By the processes described above, the content server 1 can make the user continuously watch the 3D content of the view point considered to be the most exciting.

### Second Embodiment

In the embodiment described above, the various controls such as the control of the transmission rate according to the number of accesses (transmission quality), the selection of the recording rate according to the key frame evaluation value, and the selection of the viewpoint according to the key frame evaluation value are performed by the content server 1. However, the controls may be performed by the client terminal 2.

Configurations of Devices

FIG. 13 is a block diagram illustrating an example of another functional configuration of the content server 1.

In the configurations shown in FIG. 13, the same reference numerals and signs are given to the same configurations as the configurations shown in FIG. 4. The repeated description is appropriately omitted. In the content server 1, the selection unit 32 and the transmission control unit 33 are realized. The hardware configuration of the content server 1 is the same as the configuration shown in FIG. 3.

The selection unit 32 selects the 3D content requested to be transmitted by the client terminal, from the 3D contents recorded in the recording unit 18. The selection unit 32 reads the selected 3D content from the recording unit 18, and outputs the 3D content to the transmission control unit 33.

The transmission control unit 33 transmits the 3D content supplied from the selection unit 32 to the client terminal 2.

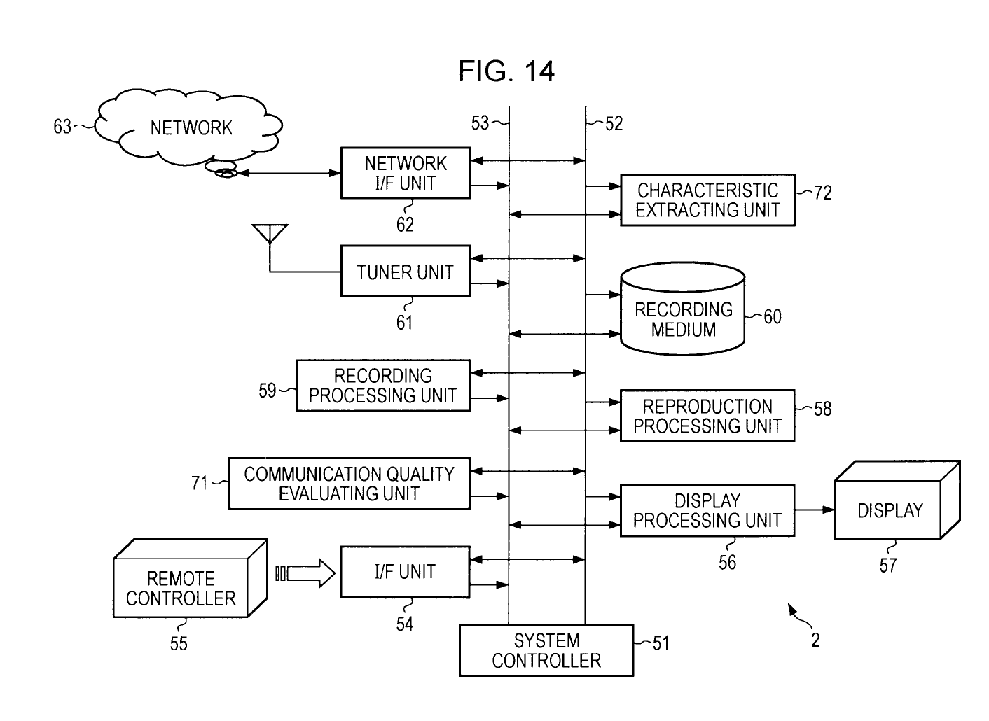

FIG. 14 is a block diagram illustrating an example of a configuration of the client terminal 2.

In the configurations shown in FIG. 14, the same reference numerals and signs are given to the same configurations as the configurations shown in FIG. 5. The repeated description is appropriately omitted. The configuration of the client terminal 2 shown in FIG. 14 is the same as the configuration shown in FIG. 5, except that a communication quality evaluating unit 71 and a characteristic extracting unit 72 are added.

The communication evaluating unit 71 detects communication quality between the content server 1 and the client terminal 2 on the basis of the reception condition of the data transmitted from the content server 1. As will be described, the communication quality between the content server 1 and the client terminal 2 is used to determine the recording rate of the 3D content requested to be transmitted.

For example, the evaluation of the communication quality is performed by analyzing the condition of the reaching of the packet. For example, evaluating the communication quality by analyzing the condition of the reaching of the packet is disclosed in Japanese Unexamined Patent Application Publication No. 2007-28526.

The characteristic extracting unit 72 extracts characteristics of the 3D content transmitted from the content server 1 in the same manner as the characteristic extracting unit 34 (FIG. 4), and calculates the key frame evaluation value for each section of the 3D contents on the basis of the extracted characteristics. The characteristic extracting unit 34 outputs the information of the key frame evaluation value for each section of the 3D contents, to the system controller 51.

Operations of Devices

Hereinafter, operations of the content server 1 and the client terminal 2 having the configurations shown in FIG. 13 and FIG. 14 will be described. The client terminal 2 performs basically the same process as the process performed by the content server 1 according to the first embodiment.

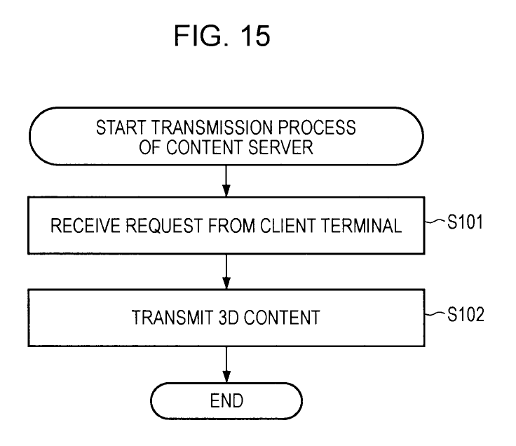

First, the process of the content server 1 transmitting the 3D content will be described with reference to the flowchart shown in FIG. 15.

In Step S101, the selection unit 32 receives the request from the accessed client terminal 2. The request from the client terminal 2 includes information designating the 3D content of the transmission target. The selection unit 32 reads the 3D content designated by the client terminal 2, and outputs the 3D content to the transmission control unit 33.

In Step S102, the transmission control unit 33 transmits the 3D content to the client terminals 2, and ends the process.

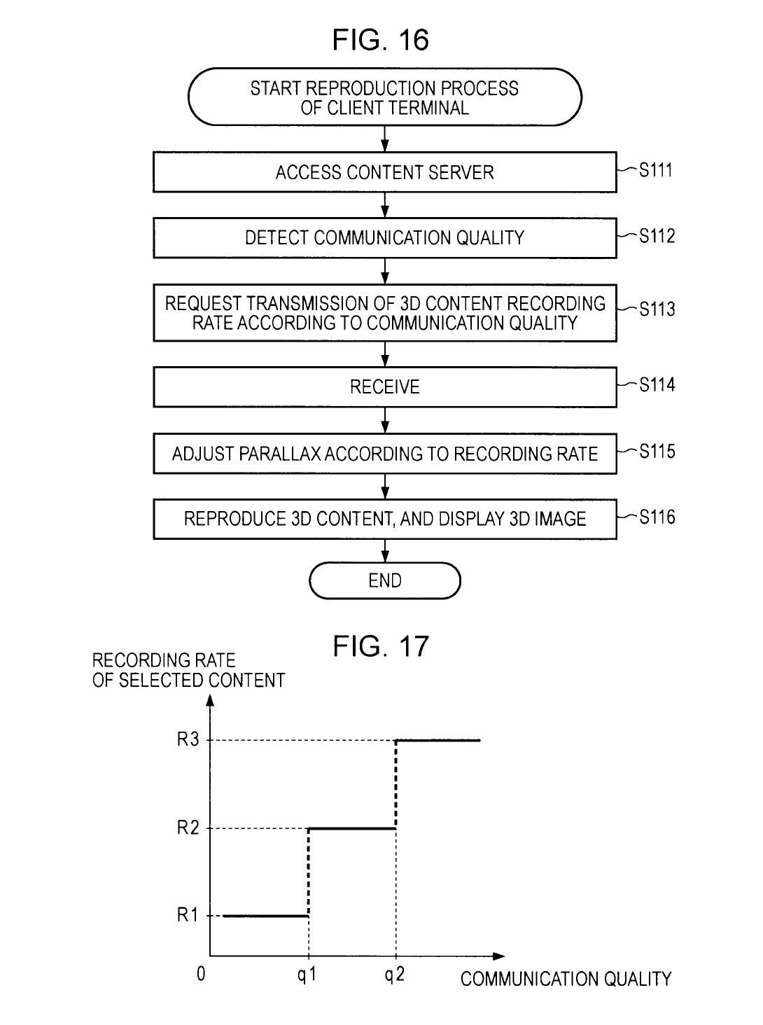

Next, a process of the client terminal 2 reproducing the 3D content will be described with reference to the flowchart shown in FIG. 16.

The process shown in FIG. 16 is a process of changing the recording rate of the 3D content requested to be transmitted, according to the communication quality between the content server 1 and the client terminal 2, and adjusting the parallax of the 3D content according to the recording rate.

In Step S111, the system controller 51 accesses to the content server 1. The network I/F unit 62 outputs the information transmitted from the content server 1, to the display processing unit 56, and displays the selection screen of the 3D content on the display 57. The user operates the remote controller 55 or the like to select the 3D content of a predetermined viewpoint included in a predetermined 3D content group, as the transmission target. Herein, the selection of the recording rate of the 3D content of the transmission target is not performed.

In Step S112, the communication quality evaluating unit 71 detects communication quality between the content server 1 and the client terminal 2 on the basis of the reception condition of the data transmitted from the content server 1.

In Step S113, the system controller 51 selects the recording rate according to the communication quality detected by the communication quality evaluating unit 71, and requests the server 1 to transmit the 3D content with the selected recording rate.

For example, when the value representing the communication quality is smaller than a threshold value, the recording rate R1 is selected. When the value is larger than the threshold value, the recording rate R2 higher than the recording rate R1 is selected. The process shown in FIG. 15 is performed in the content server 1, and the data of the designated recording rate in the data of the 3D content of the viewpoint designated by the client terminal 2 starts being transmitted to the client terminal 2.

When the data with different recording rates as the data of the 3D contents are not prepared in the content server 1, the data may be generated by the content server 1 when there is a request of the client terminal 2. In this case, the content server 1 re-encodes the data of the 3D content recorded in the recording unit 18 into the data with the recording rate designated by the client terminal 2, and transmits the re-encoded data to the client terminal 2.

In Step S114, the network I/F unit 62 receives the 3D content transmitted from the content server 1.

In Step S115, the system controller 51 adjusts the parallax of the 3D content according to the recording rate in the same manner as the parallax adjusting unit 35 (FIG. 4).

In Step S116, the reproduction processing unit 58 reproduces the 3D content with the adjusted parallax, and displays the 3D image on the display 57. When the reproduction of the 3D content selected by the user is ended, the process is ended.

FIG. 17 is a diagram illustrating relation between the communication quality and the recording rate.

The horizontal axis shown in FIG. 17 represents the communication quality, and the vertical axis represents the recording rate. In the example shown in FIG. 17, when the value representing the communication quality is equal to or more than 1 and less than q1, the recording rate of the 3D content is considered as R1 (recording rate R1), and when the value representing the communication quality is equal to or more than q1 and less than q2, the recording rate of the 3D content is R2 higher than R1. When the value representing the communication quality is equal to or more than q2, the recording rate of the 3D content is R3 higher than R2. The system controller 51 has information representing the relation between the communication quality and the recording rate, and selects the recording rate according to the information.

As described above, by controlling the recording rate of the 3D content requested to be transmitted according to the communication quality, the client terminal 2 can receive the 3D content without discontinuing the data. The user of the client terminal 2 can watch the 3D content without interruption of display or noises.

The client terminal 2 can prevent the unnatural 3-dimensional effect or fatigue from being provided to the user, by adjusting the parallax according to the recording rate, and it is possible to display a more easily visible 3D image.

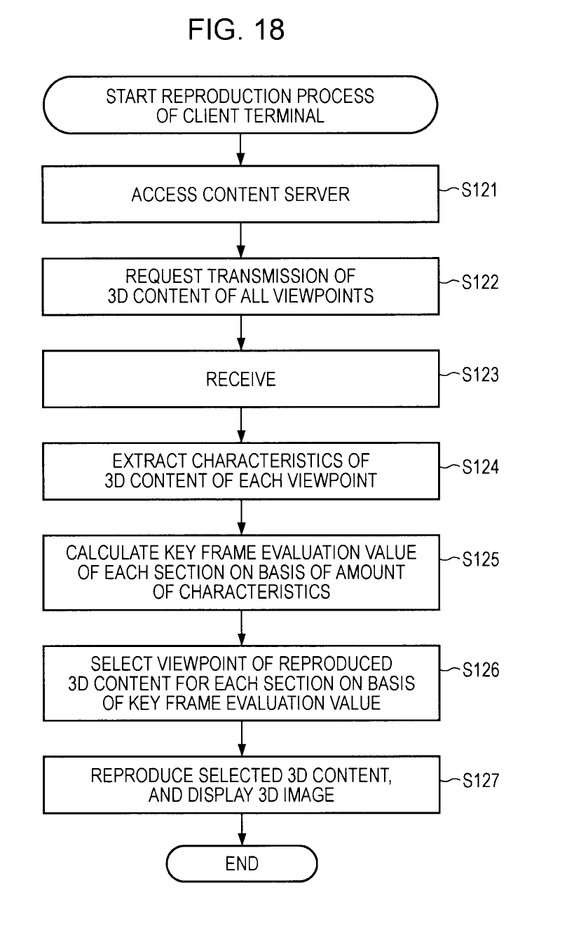

Another process of the client terminal 2 reproducing the 3D content will be described with reference to the flowchart shown in FIG. 18.

The process shown in FIG. 18 is a process of changing the viewpoint of the reproduced 3D content according to the key frame evaluation value.

In Step S121, the system controller 51 accesses the content server 1. The network I/F unit 62 outputs the information transmitted from the content server 1, to the display processing unit 56, and displays the selection screen of the 3D content on the display 57. The user operates the remote controller 55 or the like to select a predetermined 3D content group. Here, the selection of the viewpoint is not performed. The recording rate of the 3D content may be selected by the user, and may be selected according to the communication quality in the same manner as the process shown in FIG. 16.

In Step S122, the system controller 51 requests the content server 1 to transmit the 3D contents of all the viewpoints included in the 3D content group selected by the user. The process shown in FIG. 15 is performed in the content server 1, and the 3D contents of all the viewpoints included in the 3D content group designated by the client terminal 2 start being transmitted to the client terminal 2.

In Step S123, the network I/F unit 62 receives the 3D content transmitted from the content server 1.

In Step S124, the characteristic extracting unit 72 extracts characteristics of each 3D content transmitted from the content server 1. The extraction of characteristics performed by the characteristic extracting unit 72 is performed in the same manner as the process performed by the characteristic extracting unit 34 (FIG. 4). That is, the amounts of image characteristics and the amounts of sound characteristics of the 3D contents of all the viewpoints included in any 3D content group are extracted.

In Step S125, the characteristic extracting unit 72 calculates a key frame evaluation value for each section of the 3D contents on the basis of the amount of image characteristics and the amount of sound characteristics. The characteristic extracting unit 72 outputs the information of the key frame evaluation value for each section of the 3D contents of all the viewpoints included in the 3D content group, to the system controller 51.

In Step S126, the system controller 51 pays attention to the sequence from the leading section, and selects the 3D content of the viewpoint with the highest key frame evaluation value in the attended section, as the reproduction target. The system controller 51 outputs information representing the 3D content as the reproduction target in each section, to the characteristic extracting unit 72, and outputs the 3D content of the reproduction target to the reproduction processing unit 58.

Accordingly, the 3D content of the viewpoint considered as the most excitement at that time is selected as the reproduction target, and the 3D image is displayed automatically changing to the viewpoint considered to be the most exciting.

In Step S127, the reproduction processing unit 58 reproduces the 3D content selected by the system controller 51, and displays the 3D image on the display 57. When the reproduction is ended up to the last section, the process is ended.

By the processes described above, the client terminal 2 can make the user continuously watch the 3D content of the viewpoint considered to be the most exciting.

When the 3D content is reproduced by the process shown in FIG. 18, parallax adjustment according to the recording rate described above may be performed.

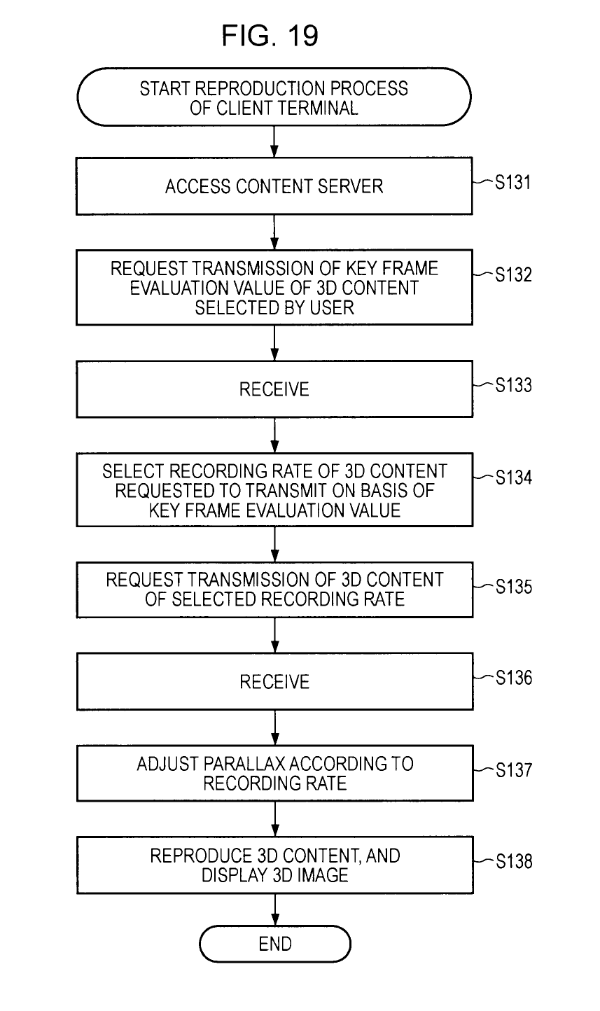

Next, still another process of the client terminal 2 reproducing the 3D content will be described with reference to the flowchart shown in FIG. 19.

The process shown in FIG. 19 is a process of changing the recording rate of the 3D content requested to be transmitted according to the key frame evaluation value, and adjusting the parallax of the 3D content according to the recording rate. In this process, the calculation of the key frame evaluation value of the 3D contents recorded in the recording unit 18 of the content server 1 is performed by the content server 1. That is, the content server 1 is provided with the characteristic extracting unit 34 shown in FIG. 4, and the information of the key frame evaluation values of the 3D contents calculated by the characteristic extracting unit 34 is recorded in the recording unit 18.

In Step S131, the system controller 51 accesses the content server 1. The network I/F unit 62 outputs the information transmitted from the content server 1, to the display processing unit 56, and displays the selection screen of the 3D content on the display 57. The user selects a 3D content of a predetermined viewpoint included in a predetermined 3D content group, as a transmission target. Herein, the selection of the recording rate of the 3D content of the transmission target is not performed.

In Step S132, the system controller 51 requests the content server 1 to transmit the information of the key frame evaluation value of the 3D content selected by the user. The information of the key frame evaluation value for each section of the 3D content selected by the user is read from the recording unit 18, and is transmitted from the content server 1.

In Step S133, the network I/F unit 62 receives the information of the key frame evaluation value transmitted from the content server 1.

In Step S134, the system controller 51 selects the recording rate of the 3D content requested to be transmitted, for each section, according to the key frame evaluation value of the section. For example, the system controller 51 selects the recording rate R2 which is a higher recording rate in the section in which the key frame evaluation value is higher than a threshold value. The system controller 51 selects the recording rate R1 which is a lower recording rate in the section in which the key frame evaluation value is lower than the threshold value.

In Step S135, the system controller 51 requests the content server 1 to transmit the data of the recording rate selected for each section, as the data of the 3D content selected by the user. The process shown in FIG. 15 is performed in the content server 1, and the data of the designated recording rate as the data of the 3D content designated by the client terminal 2 starts being transmitted to the client terminal 2.

In Step S136, the network I/F unit 62 receives the 3D content transmitted from the content server 1.

In Step S137, the system controller 51 adjusts the parallax of the 3D content according to the recording rate in the same manner as the parallax adjusting unit 35 shown in FIG. 4.

In Step S138, the reproduction processing unit 58 reproduces the 3D content with the adjusted parallax, and displays the 3D image on the display 57. When the reproduction of the 3D content selected by the user is ended, the process is ended.

According to the processes described above, the client terminal 2 can adjust the quality of the 3D image for each section according to the degree of excitement. The client terminal 2 adjusts the parallax according to the recording rate to prevent the unnatural 3-dimensional effect or fatigue from being provided to the user, and thus it is possible to display a more easily visible 3D image.

### Modified Examples

In the above description, all of the various controls such as the control of the transmission rate according to the number of accesses (transmission quality), the selection of the recording rate according to the key frame evaluation value, and the selection of the viewpoint according to the key frame evaluation value are performed by the content server 1 or the client terminal 2. However, one part of controls may be performed by the content server 1, and the other part of controls may be performed by the client terminal 2.

Program

The series of processes described above may be performed by hardware and may be performed by software. When the series of processes are performed by the software, a program constituting the software is installed in a computer provided with dedicated hardware, a general purpose personal computer, or the like.

The installed program is recorded on a removable media 21 shown in FIG. 3 and formed of an optical disc (CD-ROM (Compact Disc-Read Only Memory), a DVD (Digital Versatile Disc), etc.) or a semiconductor memory, and is provided. The program may be provided through a wired or wireless transmission medium such as a Local Area Network, the Internet, and digital broadcasting. The program may be installed in advance in the ROM 12 or the recording unit 18.

The program executed by the computer may be a program of performing a time-series process according to the sequence described in the specification, and may be a program of performing a process in a parallel manner or at the necessary timing such as the calling time.

The present disclosure contains subject matter related to that disclosed in Japanese Priority Patent Application JP 2010-211646 filed in the Japan Patent Office on Sep. 22, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a recording unit that records a 3D content including a left eye image and a right eye image;
a parallax adjusting unit that adjusts parallax between the left eye image and the right eye image of the 3D content according to a recording rate or a transmission rate of the 3D content; and
a transmission control unit that transmits the 3D content including the left eye image and the right eye image with the adjusted parallax to respective terminals as a transmission destination through a network.

2. The information processing device according to claim 1, wherein when the recording rate or the transmission rate of the 3D content is higher than a threshold value, the parallax adjusting unit adjusts the parallax between the left eye image and the right eye image such that the parallax is larger than that of a case where the recording rate or the transmission rate of the 3D content is lower than the threshold value.

3. The information processing device according to claim 1, further comprising a detection unit that detects the number of terminals,
wherein the transmission control unit determines the transmission rate of the 3D content according to the number of terminals detected by the detection unit, and
wherein the parallax adjusting unit adjusts the parallax between the left eye image and the right eye image of the 3D content according to the transmission rate determined by the transmission control unit.

4. The information processing device according to claim 1, wherein the recording unit records a plurality of 3D contents with different viewpoints, and records data with different recording rates as data of the 3D contents,
wherein the information processing device further comprises:
an extraction unit that extracts characteristics of the 3D contents, and calculates evaluation values of the 3D contents recorded on the recording unit on the basis of the extracted characteristics; and
a selection unit that selects a 3D content of a transmission target from the plurality of 3D contents with different viewpoints on the basis of the evaluation values,
wherein the parallax adjusting unit adjusts the parallax between the left eye image and the right eye image of the 3D content selected by the selection unit.

5. The information processing device according to claim 4, wherein the selection unit selects the 3D content with the highest evaluation value.

6. The information processing device according to claim 4, wherein the selection unit selects data of the recording rate based on the evaluation value, as data of the 3D content.

7. An information processing method comprising:
recording a 3D content including a left eye image and a right eye image;
adjusting parallax between the left eye image and the right eye image of the 3D content according to a recording rate or a transmission rate of the 3D content; and
transmitting the 3D content including the left eye image and the right eye image with the adjusted parallax to terminals as a transmission destination through a network.

8. A program for causing a computer to execute the processes of:
recording a 3D content including a left eye image and a right eye image;
adjusting parallax between the left eye image and the right eye image of the 3D content according to a recording rate or a transmission rate of the 3D content; and
transmitting the 3D content including the left eye image and the right eye image with the adjusted parallax to terminals as a transmission destination through a network.

9. A reproduction device comprising:
a reception unit that receives a 3D content including a left eye image and a right eye image transmitted from an information processing device connected through a network;
a parallax adjusting unit that adjusts parallax between the left eye image and the right eye image of the 3D content according to a recording rate of the 3D content; and
a reproduction unit that reproduces the 3D content including the left eye image and the right eye image with the adjusted parallax.

10. The reproduction device according to claim 9, wherein when the recording rate of the 3D content is higher than a threshold value, the parallax adjusting unit adjusts the parallax between the left eye image and the right eye image such that the parallax is larger than that of a case where the recording rate of the 3D content is lower than the threshold value.

11. The reproduction device according to claim 9, wherein a plurality of 3D contents with different viewpoints are recorded in the information processing device, and data with different recording rates are recorded as data of the 3D contents.

12. The reproduction device according to claim 11, further comprising a detection unit that detects communication quality with respect to the information processing unit,
wherein the reception unit receives the 3D content with a recording rate based on the communication quality detected by the detection unit.

13. The reproduction device according to claim 11, wherein the reception unit receives a plurality of 3D contents with different viewpoints,
wherein the reproduction device further comprises:
an extraction unit that extracts characteristics of the 3D contents received by the reception unit, and calculates evaluation values of the plurality of 3D contents with different viewpoints on the basis of the extracted characteristics; and
a selection unit that selects a 3D content with the highest evaluation value from the plurality of 3D contents with different viewpoints,
wherein the parallax adjusting unit adjusts the parallax between the left eye image and the right eye image of the 3D content selected by the selection unit.

14. The reproduction device according to claim 11, wherein the reception unit receives data with a recording rate based on the evaluation value calculated on the basis of the characteristics of the 3D content of a reproduction target, as data of the 3D content of the reproduction target, and
wherein the parallax adjusting unit adjusts the parallax between the left eye image and the right eye image of the 3D content, the data of which is selected by the reception unit.

15. The reproduction device according to claim 14, wherein the reception unit receives information of the evaluation value transmitted from the information processing device, and receives data with a recording rate based on the received evaluation value.

16. A reproduction method comprising:
receiving a 3D content including a left eye image and a right eye image transmitted from an information processing device connected through a network;
adjusting parallax between the left eye image and the right eye image of the 3D content according to a recording rate of the 3D content; and
reproducing the 3D content including the left eye image and the right eye image with the adjusted parallax.

17. A program for causing a computer to execute the processes of:
receiving a 3D content including a left eye image and a right eye image transmitted from an information processing device connected through a network;
adjusting parallax between the left eye image and the right eye image of the 3D content according to a recording rate of the 3D content; and
reproducing the 3D content including the left eye image and the right eye image with the adjusted parallax.
